(19) United States
(12) Patent Application Publication
(10) Pub. No.: US 2023/0063361 A1
(43) Pub. Date: Mar. 2, 2023

(54) RECHARGEABLE LITHIUM BATTERY

(71) Applicant: SAMSUNG SDI CO., LTD., Yongin-si (KR)

(72) Inventors: Myunghoon KIM, Yongin-si (KR); Hyunbong CHOI, Yongin-si (KR); Sanghoon KIM, Yongin-si (KR); Yunhee KIM, Yongin-si (KR); Injun PARK, Yongin-si (KR); Hongryeol PARK, Yongin-si (KR); Seungryong OH, Yongin-si (KR); Myunghwan JEONG, Yongin-si (KR)

(21) Appl. No.: 17/893,044

(22) Filed: Aug. 22, 2022

(30) Foreign Application Priority Data
Aug. 26, 2021 (KR) 10-2021-0113346

(51) Int. Cl. H01M 10/0567; H01M 10/0525; H01M 4/505; H01M 4/525; H01M 4/36

(52) U.S. Cl. CPC H01M 10/0567; H01M 4/366; H01M 4/505; H01M 4/525; H01M 10/0525; H01M 2004/028; H01M 2300/0025

(57) ABSTRACT

A rechargeable lithium battery includes a positive electrode including a positive active material; a negative electrode including a negative active material; and an electrolyte solution including a non-aqueous organic solvent, a lithium salt, and an additive, wherein the additive includes a compound represented by Chemical Formula 1, and the positive active material includes at least one lithium composite oxide represented by Chemical Formula 3.

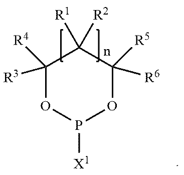

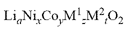

### CROSS-REFERENCE TO RELATED APPLICATION

This application claims priority to and the benefit of Korean Patent Application No. 10-2021-0113346, filed in the Korean Intellectual Property Office on Aug. 26, 2021, the entire content of which is incorporated herein by reference.

### BACKGROUND

### 1. Field

The present disclosure relates to a rechargeable lithium battery.

### 2. Description of the Related Art

A rechargeable lithium battery may be recharged and may have an energy density per unit weight as high as three or more times that of a related art lead storage (or lead acid) battery, nickel-cadmium battery, nickel hydrogen battery, nickel zinc battery and/or the like. It may also be charged at a high charging rate and thus, may be suitable (e.g., commercially manufactured) for a laptop, a cell phone, an electric tool, an electric bike, and/or the like. Researches, e.g., on improvement of energy density have been actively conducted.

For example, as information technology (IT) devices increasingly (e.g., continuously) achieve higher performance, a high-capacity battery is desired or required. While the high capacity may be realized through expansion of a voltage range, increasing the energy density may cause a problem of deteriorating performance of a positive electrode due to oxidization of an electrolyte solution in the high voltage range.

For example, LiPF₆, which is commonly (e.g., most often) utilized as a lithium salt of the electrolyte solution, may react with an electrolyte solvent to promote (or cause) depletion of the solvent and generate a large amount of gas. LiPF₆ may be decomposed and produce a decomposition product such as HF, PFs, and/or the like, which may cause the electrolyte depletion and lead to performance deterioration and insufficient safety at a high temperature.

The decomposition products of the electrolyte solution may be deposited as a film on the surface of an electrode to increase internal resistance of the battery and eventually may cause problems of deteriorated battery performance and shortened cycle-life. In addition, this side reaction is further accelerated at a high temperature where the reaction rate becomes faster, and gas components generated due to the side reaction may cause a rapid increase of an internal pressure of the battery and thus may have a strong adverse effect on the stability of the battery.

Oxidization of the electrolyte solution is accelerated (e.g., greatly accelerated) in the high voltage range and thus is known to greatly increase the resistance of the electrode during the long-term charge and discharge process.

Accordingly, there is a need for an electrolyte solution suitable for usage under conditions of a high voltage and a high temperature.

### SUMMARY

Aspects according to one or more embodiments are directed toward a rechargeable lithium battery with improved battery stability (by suppressing decomposition of an electrolyte solution and a side reaction with an electrode) and simultaneously or concurrently, with improved initial resistance and high-temperature storage characteristics (by improving impregnation of the electrolyte solution in a positive electrode).

Additional aspects will be set forth in part in the description which follows and, in part, will be apparent from the description, or may be learned by practice of the presented embodiments of the disclosure.

According to an embodiment of the present disclosure, a rechargeable lithium battery includes a positive electrode including a positive active material; a negative electrode including a negative active material; and an electrolyte solution including a non-aqueous organic solvent, a lithium salt, and an additive,

wherein the additive includes a compound represented by Chemical Formula 1, and

the positive active material includes at least one lithium composite oxide represented by Chemical Formula 3.

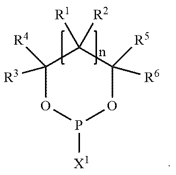

In Chemical Formula 1,
X¹ is a fluoro group (-F), a chloro group (-CI), a bromo group (-Br), or an iodo group (-I),
R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and

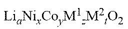

wherein, in Chemical Formula 3,
0.9 ≤ a < 1.2, 0.8 ≤ x < 1.0, 0 ≤ y ≤ 0.2, 0 < z ≤ 0.3, x + y + z = 1, 0 ≤ t ≤ 0.1,
M¹ is Mn, Al, or a combination thereof, and
M² is Ti, Mg, Zr, Ca, Nb, Fe, P, F, B, or a combination thereof.

The compound represented by Chemical Formula 1 may include a compound represented by Chemical Formula 1A or Chemical Formula 1B.

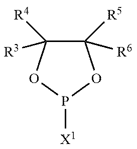

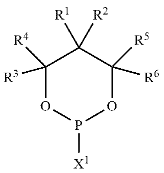

In Chemical Formula 1A and Chemical Formula 1B,
X¹ is a fluoro group (-F), a chloro group (-CI), a bromo group (-Br), or an iodo group (-I), and
R¹ to R⁶ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In Chemical Formula 1A and Chemical Formula 1B, B, R³ and R⁴ may each be hydrogen, and at least one selected from among R¹, R², R⁵, and R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In Chemical Formula 1A, R³ and R⁴ may each be hydrogen and R⁵ and/or R⁶ may each independently be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

The compound represented by Chemical Formula 1 may be about 0.1 parts by weight to about 5.0 parts by weight in amount based on 100 parts by weight of the electrolyte solution.

The compound represented by Chemical Formula 1 may be about 0.1 parts by weight to about 3.0 parts by weight in amount based on 100 parts by weight of the electrolyte solution.

The compound represented by Chemical Formula 1 may be at least one of the compounds of Group 1.

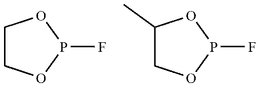

The additive may further include at least one other additive selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

In Chemical Formula 3, x may be in the range of 0.88 ≤ x < 1.0.

In Chemical Formula 3, x may be in the range of 0.88 ≤ x ≤ 0.94.

A rechargeable lithium battery according to embodiments of the present disclosure may have improved battery stability by suppressing a decomposition of the electrolyte solution and side reaction with the electrode, thereby reducing gas generation and suppressing an increase in internal resistance of the battery at the same time.

### BRIEF DESCRIPTION OF THE DRAWING

FIG. 1 The drawing is a schematic view illustrating a rechargeable lithium battery according to an embodiment.

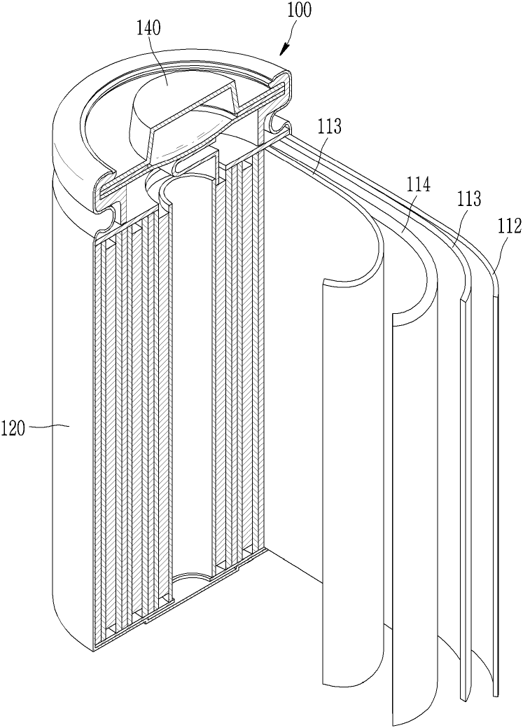

### DETAILED DESCRIPTION

Hereinafter, a rechargeable lithium battery according to embodiments of the present disclosure will be described in more detail with reference to the accompanying drawing. However, these embodiments are examples, and the present disclosure is not limited thereto and the present disclosure is defined by the scope of claims, and equivalents thereof.

Hereinafter, when a definition is not otherwise provided, “substituted” refers to replacement of hydrogen of a compound by a substituent selected from a halogen atom (F, Br, CI, or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C30 aryl group, a C7 to C30 arylalkyl group, a C1 to C4 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C2 to C20 heterocycloalkyl group, and a combination thereof.

A rechargeable lithium battery may be classified as a lithium ion battery, a lithium ion polymer battery, and a lithium polymer battery, according to the presence of a separator and the type or kind of electrolyte solution utilized therein. Rechargeable lithium battery may have a variety of suitable shapes and sizes, and non-limiting examples include cylindrical, prismatic, coin, and/or pouch-type or kind batteries, and may be thin film batteries or may be rather bulky in size. Structures and manufacturing methods for these batteries pertaining to this disclosure may be any suitable ones in the related art.

Here, a cylindrical rechargeable lithium battery will be described as an example of the rechargeable lithium battery. The drawing schematically shows the structure of a rechargeable lithium battery according to an embodiment. Referring to the drawing, a rechargeable lithium battery 100 according to an embodiment includes a battery cell including a positive electrode 114, a negative electrode 112 facing the positive electrode 114, a separator 113 between the positive electrode 114 and the negative electrode 112, and an electrolyte solution impregnating the positive electrode 114, the negative electrode 112, and the separator 113, a battery case 120 housing the battery cell, and a sealing member 140 sealing the battery case 120.

Hereinafter, a more detailed configuration of the rechargeable lithium battery 100 according to an embodiment will be described.

A rechargeable lithium battery according to an embodiment includes a positive electrode, a negative electrode, and an electrolyte solution.

The electrolyte solution includes a non-aqueous organic solvent, a lithium salt, and an additive, and the additive includes a compound represented by Chemical Formula 1.

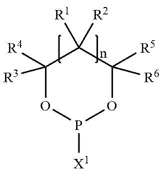

In Chemical Formula 1,
X¹ is a fluoro group (-F), a chloro group (-CI), a bromo group (-Br), or an iodo group (-I),
R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
n is 0 or 1.

The compound represented by Chemical Formula 1 forms a solid electrolyte interface (SEI) film having high high-temperature stability and excellent ion conductivity on the surface of the negative electrode, and suppresses a side reaction of LiPF₆ due to the functional group such as -PO₂F and thus reduce gas generation due to a decomposition reaction of the electrolyte when stored at a high temperature.

For example, the compound represented by Chemical Formula 1 may be coordinated with a pyrolyzed product of a lithium salt such as LiPF₆ or anions dissociated from the lithium salt and thus form a complex, and the complex formation may stabilize the pyrolyzed product of the lithium salt such as LiPF₆ or the anions dissociated from the lithium salt to suppress undesired side reaction of the anions with the electrolyte solution. Accordingly, the cycle-life characteristics of the rechargeable lithium battery may be improved, and gas generation inside the rechargeable lithium battery may be prevented or reduced, thereby reducing (e.g., remarkably reducing) a failure rate.

The compound represented by Chemical Formula 1 may be represented by Chemical Formula 1A or Chemical Formula 1B.

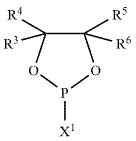

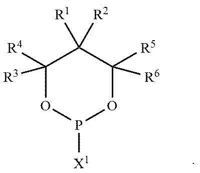

In Chemical Formula 1A and Chemical Formula 1B, B,
X¹ is a fluoro group (-F), a chloro group (-CI), a bromo group (-Br), or an iodo group (-I), and
R¹ to R⁶ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In Chemical Formula 1A and Chemical Formula 1B, B, R³ and R⁴ may each be hydrogen, and at least one selected from among R¹, R², R⁵, and R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

For example, the compound represented by Chemical Formula 1 may be represented by Chemical Formula 1A.

In an embodiment, in Chemical Formula 1A, R³ and R⁴ may each be hydrogen, and R⁵ and/or R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

For example, in Chemical Formula 1A, R³ and R⁴ may each be hydrogen, and R⁵ and/or R⁶ may be a substituted or unsubstituted C1 to C10 alkyl group.

The compound represented by Chemical Formula 1 may be included in an amount of about 0.1 parts by weight to about 5.0 parts by weight, for example, about 0.1 parts by weight to about 3.0 parts by weight, or about 0.1 parts by weight to about 2.0 parts by weight based on 100 parts by weight of the electrolyte solution

When the amount of the compound represented by Chemical Formula 1 is within the above ranges, a rechargeable lithium battery having improved high-temperature storage characteristics and cycle-life characteristics may be implemented (e.g., achieved).

For example, the compound represented by Chemical Formula 1 may be one of the compounds of Group 1, and may be, for example, 2-fluoro-1,3,2-dioxaphospholane and/or 2-fluoro-4-methyl-1,3,2-dioxaphospholane.

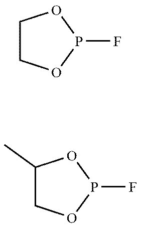

In some embodiments, the additive may further include other additive(s) in addition to the aforementioned compound.

The other additives may include at least one selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

By further including the aforementioned other additives, cycle-life may be further improved and/or gases generated from the positive electrode and the negative electrode may be effectively controlled during high-temperature storage.

The other additives may be included in an amount of about 0.2 parts by weight to about 20 parts by weight, for example, about 0.2 parts by weight to about 15 parts by weight, or about 0.2 parts by weight to about 10 parts by weight, based on 100 parts by weight of the electrolyte solution for a rechargeable lithium battery.

When the content of other additives is as described above, the increase in film resistance may be minimized or reduced, thereby contributing to the improvement of battery performance.

The non-aqueous organic solvent serves as a medium for transmitting ions taking part in the electrochemical reaction of a battery.

The non-aqueous organic solvent may be a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, t-butyl acetate, methyl propionate, ethyl propionate, propyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. In addition, the ketone-based solvent may include cyclohexanone, and/or the like. The alcohol-based solvent may include ethanol, isopropyl alcohol, and/or the like, and the aprotic solvent may include nitriles such as R-CN (wherein R is a hydrocarbon group having a C2 to C20 linear, branched, or cyclic structure and may include a double bond, an aromatic ring, or an ether bond), and/or the like, amides such as dimethyl formamide, and/or the like, dioxolanes such as 1,3-dioxolane, and/or the like, sulfolanes, and/or the like.

The non-aqueous organic solvent may be utilized alone or in a mixture. When the organic solvent is utilized in a mixture, the mixing ratio may be controlled in accordance with a desirable battery performance.

The carbonate-based solvent may be prepared by mixing a cyclic carbonate and a linear carbonate. When the cyclic carbonate and linear carbonate are mixed together in a volume ratio of about 5:5 to about 1:9, a performance of the electrolyte solution may be improved.

In an embodiment, the non-aqueous organic solvent may include the cyclic carbonate and the linear carbonate in a volume ratio of about 5:5 to about 2:8, and for example, the cyclic carbonate and the linear carbonate may be included in a volume ratio of about 4:6 to about 2:8.

In an embodiment, the cyclic carbonate and the linear carbonate may be included in a volume ratio of about 3:7 to about 2:8.

The non-aqueous organic solvent may further include an aromatic hydrocarbon-based organic solvent in addition to the carbonate-based solvent. Herein, the carbonate-based solvent and the aromatic hydrocarbon-based organic solvent may be mixed in a volume ratio of about 1:1 to about 30:1.

The aromatic hydrocarbon-based organic solvent may be an aromatic hydrocarbon-based compound represented by Chemical Formula 2.

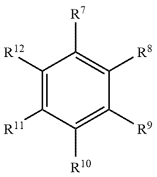

In Chemical Formula 2, R⁷ to R¹² are the same or different and are each independently hydrogen, a halogen, a C1 to C10 alkyl group, a haloalkyl group, or a combination thereof.

Examples of the aromatic hydrocarbon-based organic solvent may include (e.g., may be) benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The lithium salt dissolved in the non-organic solvent supplies lithium ions in a battery, enables a basic operation of a rechargeable lithium battery, and improves transportation of the lithium ions between positive and negative electrodes. Examples of the lithium salt may include at least one supporting salt selected from LiPF₆, LiBF₄, lithium difluoro(oxalate)borate (LiDFOB), LiPO₂F₂, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), LiC₄F₉SO₃, LiCIO₄, LiAIO₂, LiAICI₄, LiN(CₓF₂ₓ+₁SO₂)(C_{y}F_{2y}+₁SO₂) (wherein, x and y are natural numbers, for example, an integer ranging from 1 to 20), LiCI, Lil, and LiB(C₂O₄)₂ (lithium bis(oxalato) borate, LiBOB). The lithium salt may be utilized in a concentration ranging from about 0.1 M to about 2.0 M. When the lithium salt is included at the above concentration range, an electrolyte may have suitable or excellent performance and lithium ion mobility due to optimal electrolyte conductivity and viscosity.

The positive electrode includes a positive electrode current collector and a positive active material layer formed on the positive electrode current collector, and the positive active material layer includes a positive active material.

The positive active material may include at least one type or kind of lithium composite oxide represented by Chemical Formula 3.

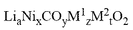

In Chemical Formula 3,
0.9 ≤ a < 1.2, 0.8 ≤ x < 1.0, 0 ≤ y ≤ 0.2, 0 < z ≤ 0.3, x + y + z = 1, 0 ≤ t ≤ 0.1
M¹ is Mn, Al, or a combination thereof, and
M² is Ti, Mg, Zr, Ca, Nb, Fe, P, F, B, or a combination thereof.

The lithium composite oxide may have a coating layer on the surface thereof, or the lithium composite oxide may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating process may include any suitable related art processes as long as it does not cause any side effects on the properties of the positive active material (e.g., ink jet coating, dipping, etc.), which is well known to persons having ordinary skill in this art, so a detailed description thereof is not provided.

In Chemical Formula 3, x may be in the range of 0.88 ≤ x < 1.0.

In Chemical Formula 3, x may be in the range of 0.88 ≤ x ≤ 0.94.

In an embodiment, x in Chemical Formula 3 may be 0.88, 0.91, or 0.94.

The content of the positive active material may be about 90 wt% to about 98 wt% based on the total weight of the positive active material layer.

In an embodiment, the positive active material layer may include a binder. The content of the binder may be about 1 wt% to about 5 wt% based on the total weight of the positive active material layer.

The binder improves binding properties of positive active material particles with one another and with a current collector. Examples thereof may include (e.g., may be) polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the present disclosure is not limited thereto.

The positive electrode current collector may include Al, but the present disclosure is not limited thereto.

The negative electrode includes a negative electrode current collector and a negative active material layer including a negative active material formed on the negative electrode current collector.

The negative active material may include a material that is capable of reversibly intercalates/de-intercalates lithium ions, a lithium metal, a lithium metal alloy, a material capable of doping/de-doping lithium, and/or a transition metal oxide.

The material that is capable of reversibly intercalates/de-intercalates lithium ions includes one or more carbon materials. The carbon material may be any generally-utilized carbon-based negative active material in a rechargeable lithium battery. Examples of the carbon material may include crystalline carbon, amorphous carbon, and a combination thereof. The crystalline carbon may be non-shaped (e.g., irregularly shaped), or sheet, flake, spherical, and/or fiber shaped natural graphite and/or artificial graphite. The amorphous carbon may be a soft carbon, a hard carbon, a mesophase pitch carbonized product, calcined coke, and/or the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material capable of doping and de-doping lithium may include Si, SiOₓ (0 < x < 2), a Si-Q alloy (wherein Q is selected from an alkali metal, an alkaline-earth metal, a Group 13 element, a Group 14 element excluding Si, a Group 15 element, a Group 16 element, a transition metal, a rare earth element, and a combination thereof), Sn, SnO₂, a Sn-R alloy (wherein R is an alkali metal, an alkaline-earth metal, a Group 13 element, a Group 14 element excluding Sn, a Group 15 element, a Group 16 element, a transition metal, a rare earth element, or a combination thereof), and/or the like. At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, lr, Pd, Pt, Cu, Ag, Au, Zn, Cd, B, Al, Ga, Sn (excluded for R), In, Tl, Ge, P, As, Sb, Bi, S, Se, Te, Po, and a combination thereof.

The transition metal oxide may be a vanadium oxide, a lithium vanadium oxide, and/or the like.

The negative active material according to an embodiment may include graphite and/or a Si composite.

When the negative active material includes the Si composite and graphite together, the Si composite and graphite may be included in the form of a mixture, and the Si composite and graphite may be included in a weight ratio of about 1:99 to about 50:50. For example, the Si composite and graphite may be included in a weight ratio of about 3: 97 to about 20: 80 or about 5: 95 to about 20: 80.

The Si composite may include a core including one or more Si-based particles and an amorphous carbon coating layer. For example, the core including the Si-based particles may include at least one selected from Si particles, a Si-C composite, SiOx (0 < x ≤ 2), and a Si alloy. For example, the center region of the core may include pores.

For example, a radius of the center region of the core may correspond to 30% to 50% of a radius of the negative active material, and the average particle diameter of the Si-based particles may be 10 nm to 200 nm.

When the average particle diameter of the Si-based particles is within the above ranges, volume expansion during charging and discharging may be suppressed, and interruption of a conductive path due to particle crushing during charging and discharging may be prevented or reduced.

In an embodiment, the center region does not include an amorphous carbon, and an amorphous carbon exists only the surface region of the negative active material.

The negative active material may further include a crystalline carbon.

The crystalline carbon may include, for example, graphite, such as natural graphite, artificial graphite, or a mixture thereof.

In the present specification, an average particle diameter may be a particle size (D50) at a volume ratio of 50% in a cumulative size-distribution curve. For example, the average particle diameter may be, for example, a median diameter (D50) measured utilizing a laser diffraction particle diameter distribution meter. Also, as used herein, the singular forms “a”, “an” and “the” are intended to include the plural forms as well, unless the context clearly indicates otherwise.

The amorphous carbon may include soft carbon, hard carbon, a mesophase pitch carbonized product, calcined coke, or a mixture thereof.

The amorphous carbon may be included in an amount of about 1 part by weight to 50 parts by weight, for example, about 5 parts by weight to about 50 parts by weight, or about 10 parts by weight to about 50 parts by weight based on 100 parts by weight of the negative electrode active material.

In the negative active material layer, the negative active material may be included in an amount of about 95 wt% to about 99 wt% based on the total weight of the negative active material layer.

In an embodiment, the negative active material layer may include a binder, and optionally a conductive material. The content of the binder in the negative active material layer may be about 1 wt% to about 5 wt% based on the total weight of the negative active material layer. In the case of a conductive material is further included in the negative active material layer, the amount of the negative active material may be about 90 wt% to about 98 wt%, the amount of the binder may be about 1 wt% to about 5 wt%, and the amount of the conductive material may be about 1 wt% to about 5 wt% based on the total weight of the negative active material layer.

The binder improves binding properties of negative active material particles with one another and with a current collector. The binder may be a non-water-soluble binder, a water-soluble binder, or a combination thereof.

The non-water-soluble binder may be polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder and/or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropyleneco polymer, polyethylene oxide, polyvinylpyrrolidone, polyepichlorohydrine, polyphosphazene, polyacrylonitrile, polystyrene, an ethylene propylene diene copolymer, polyvinylpyridine, chlorosulfonated polyethylene, latex, a polyester resin, an acrylic resin, a phenolic resin, an epoxy resin, polyvinyl alcohol, and a combination thereof.

When the water-soluble binder is utilized as a negative electrode binder, a cellulose-based compound may be further utilized to provide a suitable viscosity as a thickener. The cellulose-based compound includes one or more selected from among carboxymethyl cellulose, hydroxypropylmethyl cellulose, methyl cellulose, and alkali metal salts thereof. The alkali metals may be Na, K, and/or Li. Such a thickener may be included in an amount of about 0.1 to about 3 parts by weight based on 100 parts by weight of the negative active material.

The conductive material is included to provide electrode conductivity. Any suitable electrically conductive material may be utilized as a conductive material unless it causes a chemical change. Examples of the conductive material may include a carbon-based material such as natural graphite, artificial graphite, carbon black, acetylene black, ketjen black, a carbon fiber, and/or the like; a metal-based material including a metal powder and/or a metal fiber of copper, nickel, aluminum silver, and/or the like; a conductive polymer such as a polyphenylene derivative; or a mixture thereof.

The negative electrode current collector may be selected from a copper foil, a nickel foil, a stainless steel foil, a titanium foil, a nickel foam, a copper foam, a polymer substrate coated with a conductive metal, and a combination thereof.

The rechargeable lithium battery may further include a separator between the negative electrode and the positive electrode, depending on a type or kind of the battery. Such a separator may include, for example, polyethylene, polypropylene, or polyvinylidene fluoride, or multi-layers thereof such as a polyethylene/polypropylene double-layered separator, a polyethylene/polypropylene/polyethylene triple-layered separator, or a polypropylene/polyethylene/polypropylene triple-layered separator.

Hereinafter, examples of the present disclosure and comparative examples are described. These examples, however, are not in any sense to be interpreted as limiting the scope of the present disclosure.

### Manufacture of Rechargeable Lithium Battery Cell

### Example 1

LiNi_{0.88}CO_{0.105}AI_{0.015}O₂ as a positive active material, polyvinylidene fluoride as a binder, and acetylene black as a conductive material were mixed in a weight ratio of 96:3:1 and then, dispersed in N-methyl pyrrolidone, thereby preparing a positive active material slurry.

The positive active material slurry was coated on a 15 µ m-thick Al foil and then, dried at 100° C. and pressed, thereby manufacturing a positive electrode.

A negative active material prepared by mixing artificial graphite and a Si-C composite in a weight ratio of 93:7, a styrene-butadiene rubber binder, and carboxylmethyl cellulose were mixed in a weight ratio of 98:1:1 and then, dispersed in distilled water, thereby preparing negative active material slurry.

The Si-C composite included a core including artificial graphite and silicon particles and a coal-based pitch coating on the surface of the core.

The negative active material slurry was coated on a 10 µ m-thick Cu and then, dried at 100° C. and pressed, thereby manufacturing a negative electrode.

The positive electrode and the negative electrode were assembled with a 10 µ m-thick polyethylene separator to manufacture an electrode assembly, and an electrolyte solution was implanted thereinto, thereby manufacturing a rechargeable lithium battery cell.

The electrolyte solution had a composition as follows.

### Composition of Electrolyte Solution

Salt: LiPF₆ 1.5 M

Solvent: ethylene carbonate: ethylmethyl carbonate: dimethyl carbonate (EC:EMC:DMC = 20:10:70 in a volume ratio)

Additives: 0.5 parts by weight of 2-fluoro-4-methyl-1 ,3,2-dioxaphospholane/10 parts by weight of fluoroethylene carbonate (FEC)/0.5 parts by weight of succinonitrile (SN). That is, the additives include 0.5 parts by weight of 2-fluoro-4-methyl-1,3,2-dioxaphospholane as the additive according to embodiments of the present disclosure (hereinafter referred to as “the additive”), and further include 10 parts by weight of fluoroethylene carbonate (FEC) and 0.5 parts by weight of succinonitrile (SN) as the other additives.

Herein, in the electrolyte solution composition, the term “parts by weight” refers to a relative weight of each additive based on 100 parts by weight of the entire electrolyte solution (lithium salt + non-aqueous organic solvent).

### Examples 2 and 3

Each rechargeable lithium battery cell was manufactured in substantially the same manner as Example 1 except that the electrolyte solution was prepared by changing the content of the additive (e.g., 2-fluoro-4-methyl-1,3,2-dioxaphospholane) into 1.0 parts by weight and 3.0 parts by weight, respectively.

### Examples 4 to 6

Each rechargeable lithium battery cell was manufactured in substantially the same manner as a respective one selected from Examples 1 to 3 except that the positive electrode was manufactured by utilizing LINi₀.₉₁Co₀.₀₇₅AI₀.₀₁₅O₂ as the positive active material.

### Examples 7 to 9

Each rechargeable lithium battery cell was manufactured in substantially the same manner as a respective selected from Examples 1 to 3 except that the positive electrode was manufactured by utilizing LiNi₀.₉₄CO₀.₀₄₅AI₀.₀₁₅O₂ as the positive active material.

### Comparative Examples 1 to 3

Each rechargeable lithium battery cell was manufactured respectively in substantially the same manner as a respective one selected from Examples 1, 4, and 7 except that an electrolyte solution was prepared without adding the additive (e.g., 2-fluoro-4-methyl-1,3,2-dioxaphospholane), respectively.

### Comparative Examples 4 to 7

Each rechargeable lithium battery cell was manufactured respectively in the same manner as a respective one selected from Comparative Example 1 and Examples 1 to 3 except that each positive electrode was manufactured by utilizing LiNi₀.₆CO₀.₂AI₀.₂O₂ as the positive active material.

### Comparative Examples 8 to 11

Each rechargeable lithium battery cell was manufactured respectively in the same manner as a respective selected from Comparative Example 1 and Examples 1 to 3 except that each positive electrode was manufactured by utilizing LiNi₀.₅CO₀.₂AI₀.₃O₂ as the positive active material.

### Comparative Examples 12 to 15

Each rechargeable lithium battery cell was manufactured respectively in the same manner as a respective one selected from Comparative Example 1 and Examples 1 to 3 except that each positive electrode was manufactured by utilizing LiNi₀.₃₃Co₀.₃₃AI₀.₃₃O₂ as the positive active material.

### Evaluation 1: Evaluation of High-temperature Storage Characteristics

The rechargeable lithium battery cells according to Examples 1 to 9 and Comparative Examples 1 to 15 were measured with respect to initial DC resistance (DCIR) as ΔV/Δl (change in voltage / change in current), and after changing a maximum energy state inside the battery cells into a full charge state (SOC 100%) and storing the cells in this state at a high temperature (60° C.) for 30 days, the cells were measured with respect to DC resistance to calculate a DCIR increase rate (%) according to Equation 1, and the results are shown in Table 1.

Equation 1

DCIR increase rate = {(DCIR after 30 days - initial DCIR) / initial DCIR} X 100%

### Evaluation 2: Evaluation of High-temperature Storage Characteristics

The rechargeable lithium battery cells according to Examples 1 to 9 and Comparative Examples 1 to 15 were measured with respect to Current Interrupt Device (CID) open time to evaluate high-temperature storage characteristics, and the results are shown in Table 1.

After twice carrying out formation charge/discharge at 0.2 C/0.5 C and then, once carrying out a charge/discharge experiment at standard charge/discharge current density of 0.5 C/0.2 C, a charge cut-off voltage of 4.2 V (Li/graphite), and a discharge cut-off voltage of 3.0 V (Li/graphite), the cells were placed in a 90° C. chamber for 60 hours and then, measured with respect to the CID open time.

The compositions and the evaluation results of the rechargeable lithium battery cells are shown in Table 1.

Table 1

| | Ni content (wt%) | Content of additive (wt%) | Initial DCIR (mOh m) | DCIR after high-temp erature storage (mOhm) | DCIR Increase rate (%) | CID open time (@90° C., hr) |
|---|---|---|---|---|---|---|
| Comparative Example 1 | 88 | 0 | 30.1 | 33.6 | 11.6 | 51 (100%) |
| Example 1 | 88 | 0.5 | 30.3 | 33.5 | 10.6 | 62 (122%) |
| Example 2 | 88 | 1.0 | 30.8 | 33.1 | 7.5 | 68 (133%) |
| Example 3 | 88 | 3.0 | 31.2 | 33.4 | 7.1 | 75 (147%) |
| Comparative Example 2 | 91 | 0 | 29.2 | 33 | 13.0 | 45 (100%) |
| Example 4 | 91 | 0.5 | 29.4 | 32.5 | 10.5 | 52 (116%) |
| Example 5 | 91 | 1.0 | 30.3 | 32.1 | 5.9 | 55 (122%) |
| Example 6 | 91 | 3.0 | 31.0 | 33.0 | 6.5 | 70 (156%) |
| Comparative Example 3 | 94 | 0 | 28.9 | 32.0 | 10.7 | 31 (100%) |
| Example 7 | 94 | 0.5 | 28.8 | 31.5 | 9.4 | 38 (123%) |
| Example 8 | 94 | 1.0 | 29.2 | 31.6 | 8.2 | 45 (141%) |
| Comparative Example 4 | 60 | 0 | 41.0 | 45.0 | 9.8 | 55 (100%) |
| Comparative Example 5 | 60 | 0.5 | 41.2 | 45.5 | 10.4 | 59 (107%) |
| Comparative Example 6 | 60 | 1.0 | 41.8 | 46.1 | 10.3 | 65 (119%) |
| Comparative Example 7 | 60 | 3.0 | 42.0 | 48.0 | 14.3 | 68 (124%) |
| Comparative Example 8 | 50 | 0 | 45.0 | 50.0 | 11.1 | 61 (100%) |
| Comparative Example 9 | 50 | 0.5 | 45.1 | 51.2 | 13.5 | 64 (105%) |
| Comparative Example 10 | 50 | 1.0 | 45.5 | 52.0 | 14.3 | 68 (111%) |
| Comparative Example 11 | 50 | 3.0 | 46.2 | 53.0 | 14.7 | 70 (115%) |
| Comparative Example 12 | 33 | 0 | 49.0 | 54.0 | 10.2 | 64 (100%) |
| Comparative Example 13 | 33 | 0.5 | 49.6 | 54.9 | 10.7 | 68 (106%) |
| Comparative Example 14 | 33 | 1.0 | 51.5 | 57.6 | 11.8 | 75 (117%) |
| Comparative Example 15 | 33 | 3.0 | 53.1 | 59.9 | 12.8 | 76 (119%) |

Referring to Table 1, a rechargeable lithium battery that simultaneously includes an electrolyte solution including an additive according to embodiments of the present disclosure and a high Ni positive active material exhibited effects of reduced gas generation and simultaneously, increased internal resistance.

For example, the compositions according to Examples 1 to 3, 4 to 6, and 7 to 9, in which the Ni content was respectively 88%, 91%, and 94%, compared with the compositions according to Comparative Examples 5 to 7, 9 to 11, and 13 to 15, in which the Ni content was respectively 60%, 50%, and 30%, exhibited much improved gas reduction characteristics relative to the compositions including no additives and when comparing the compositions including the additives in the same contents. The reason is that the higher the Ni content was, the more the electrolyte solution was oxidized on the surface of the positive active material in a high charge state, which caused storability deterioration at a high temperature, but the composition according to the present disclosure was effective to prevent or reduce this severe problem.

As used herein, the term “and/or” includes any and all combinations of one or more of the associated listed items. Throughout the disclosure, the expression, such as “at least one of a, b or c”, “at least one selected from a, b, and c”, “at least one selected from the group consisting of a, b, and c”, etc., indicates only a, only b, only c, both (e.g., simultaneously) a and b, both (e.g., simultaneously) a and c, both (e.g., simultaneously) b and c, all of a, b, and c, or variation(s) thereof.

The use of “may” when describing embodiments of the present disclosure refers to “one or more embodiments of the present disclosure”.

As used herein, the terms “substantially”, “about”, and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ± 30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While this disclosure has been described in connection with what is presently considered to be practical example embodiments, it is to be understood that the disclosure is not limited to the disclosed embodiments, but, on the contrary, is intended to cover various modifications and equivalent arrangements included within the spirit and scope of the appended claims, and equivalents thereof.

### DESCRIPTION OF SYMBOLS

100: rechargeable lithium battery
112: negative electrode
113: separator
114: positive electrode
120: battery case
140: sealing member

What is claimed is:

1. A rechargeable lithium battery, comprising
a positive electrode comprising a positive active material;
a negative electrode comprising a negative active material; and
an electrolyte solution comprising a non-aqueous organic solvent, a lithium salt, and an additive,
wherein the additive comprises a compound represented by Chemical Formula 1, and
the positive active material comprises at least one lithium composite oxide represented by Chemical Formula 3:
Chemical Formula 1 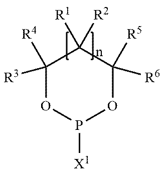
wherein, in Chemical Formula 1,
X¹ is a fluoro group (-F), a chloro group (-CI), a bromo group (-Br), or an iodo group (-I),
R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
n is 0 or 1; 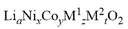
wherein, in Chemical Formula 3, 0.9 ≤ a < 1.2, 0.8 ≤ x < 1.0, 0 ≤ y ≤ 0.2, 0 < z ≤ 0.3, x + y + z = 1, 0 ≤ t ≤ 0.1,
M¹ is Mn, Al, or a combination thereof, and
M² is Ti, Mg, Zr, Ca, Nb, Fe, P, F, B, or a combination thereof.

2. The rechargeable lithium battery of claim 1, wherein
the compound represented by Chemical Formula 1 is represented by Chemical Formula 1A or Chemical Formula 1B: 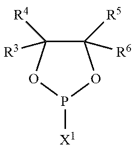 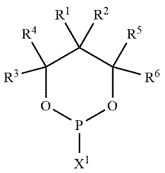
wherein, in Chemical Formula 1A and Chemical Formula 1B,
X¹ is a fluoro group (-F), a chloro group (-CI), a bromo group (-Br), or an iodo group (-I), and
R¹ to R⁶ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

3. The rechargeable lithium battery of claim 2, wherein
in Chemical Formula 1A, R³ and R⁴ are each hydrogen, and
R⁵ and/or R⁶ is a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

4. The rechargeable lithium battery of claim 1, wherein
the compound represented by Chemical Formula 1 is about 0.1 parts by weight to about 5.0 parts by weight in amount based on 100 parts by weight of the electrolyte solution.

5. The rechargeable lithium battery of claim 1, wherein
the compound represented by Chemical Formula 1 is about 0.1 parts by weight to about 3.0 parts by weight in amount based on 100 parts by weight of the electrolyte solution.

6. The rechargeable lithium battery of claim 1, wherein
the compound represented by Chemical Formula 1 is at least one selected from compounds of Group 1: 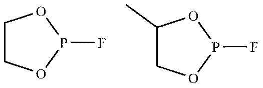
.

7. The rechargeable lithium battery of claim 1, wherein
the additive further comprises at least one other additive selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

8. The rechargeable lithium battery of claim 1, wherein
in Chemical Formula 3, x is in a range of 0.88 ≤ x < 1.0.

9. The rechargeable lithium battery of claim 1, wherein
in Chemical Formula 3, x is in a range of 0.88 ≤ x ≤ 0.94.

10. The rechargeable lithium battery of claim 1, wherein
the negative active material comprises graphite and/or a Si composite.

11. The rechargeable lithium battery of claim 10, wherein
the Si composite comprises a core comprising at least one Si-based particles and an amorphous carbon coating layer.

12. The rechargeable lithium battery of claim 11, wherein
the core comprising the Si-based particles comprises at least one selected from Si particles, a Si-C composite, SiOₓ (0 < x ≤ 2), and a Si alloy.

13. The rechargeable lithium battery of claim 12, wherein
the center region of the core comprises pores.

14. The rechargeable lithium battery of claim 13, wherein
a radius of the center region of the core corresponds to 30% to 50% of a radius of the negative active material, and
the at least one Si-based particle has the average particle diameter of 10 nm to 200 nm.

15. The rechargeable lithium battery of claim 13, wherein
the center region does not include an amorphous carbon, and the amorphous carbon exists only in a surface region of the negative active material.

16. The rechargeable lithium battery of claim 12, wherein
the negative active material further comprises crystalline carbon.
